(19) United States
(12) Patent Application Publication
(10) Pub. No.: US 2019/0075529 A1
(43) Pub. Date: Mar. 7, 2019

(54) Method For Automatically Controlling A Transmission Mode Of An Aircraft, And Aircraft Having An Apparatus For Automatically Controlling A Transmission Mode Of The Aircraft

(71) Applicant: Airbus Operations GmbH, Hamburg (DE)

(72) Inventors: Christian Schaupmann, Hamburg (DE); Peter Donner, Hamburg (DE)

(73) Assignee: Airbus Operations GmbH, Hamburg (DE)

(21) Appl. No.: 16/118,715

(22) Filed: Aug. 31, 2018

(30) Foreign Application Priority Data
Sep. 5, 2017 (DE) 10 2017 215 603.1

(51) Int. Cl. H04W 52/38; G01S 13/56; G01S 7/00

(52) U.S. Cl. CPC H04W 52/38; G01S 7/006; G01S 13/56

(57) ABSTRACT

A method for automatically controlling a transmission mode of an aircraft while the aircraft is communicating with a satellite is presented. In method step A), a transmission signal is generated by a transmission apparatus. In method step B), the transmission signal is transmitted to the satellite via an antenna of the aircraft that is set up to communicate with the satellite. In method step C), it is detected when a person stays inside or at an edge of a safety zone around the antenna by an apparatus for receiving radiation from the person via the antenna if the person is inside or at the edge of the safety zone. In method step D), the transmission of the transmission signal is automatically stopped or the transmission power of the transmission signal is automatically reduced by the transmission apparatus.

### FIELD OF THE INVENTION

The present invention relates to a method for automatically controlling a transmission mode of an aircraft and to an aircraft having an apparatus for automatically controlling a transmission mode of the aircraft.

### BACKGROUND OF THE INVENTION

Limit values of radiation intensities with respect to persons usually need to be complied with in the case of radio-frequency (RF) communication during communication between aircraft and satellites. This is important, in particular, during maintenance or in the case of repairs or service work on aircraft on the ground since persons can also come close to the antennas of the aircraft while the aircraft stays on the ground. Different aircraft and antenna types have differences in radiation characteristics and in manual switch-off systems for the transmission mode, which must be learnt by the operator before working on the aircraft in order to ensure the safety of the operator and other persons on the aircraft. In this case, it is desirable to monitor a safety zone around the antenna.

The documents U.S. Pat. Nos. 6,954,620 B1 and 5,802,445 A, for example, therefore describe different procedures and monitoring units for monitoring the emitted radiation and manually ensuring that the conventional limit values for the radiation with respect to persons are complied with during an RF transmission mode when an aircraft is communicating with a satellite.

### BRIEF SUMMARY OF THE INVENTION

Against this background, it is an idea the present invention to specify a method and an aircraft having an apparatus, with which, during a transmission mode of the aircraft, the control of the transmission mode can be improved, in particular can be automated. Furthermore, improved compliance with limit values for the radiation load on persons (and operators) in the vicinity of the aircraft can be ensured.

In the method for automatically controlling a transmission mode of an aircraft while the aircraft is communicating with a satellite, a transmission signal is generated by means of a transmission apparatus in method step A). In method step B), the transmission signal is transmitted to the satellite via an antenna of the aircraft that is set up to communicate with the satellite. In method step C), it is detected when a person stays inside or at an edge of a safety zone around the antenna by means of an apparatus for receiving radiation from the person via the antenna if the person is inside or at the edge of the safety zone. In method step D), the transmission of the transmission signal is automatically stopped or a transmission power of the transmission signal is automatically reduced by means of the transmission apparatus.

The safety zone of the aircraft advantageously extends above the aircraft around the antenna and advantageously has the shape of a hemisphere, in which case the antenna is at the centre of the hemisphere. An object or a person at the edge of or inside the safety zone can be exposed to an electromagnetic radiation load in the transmission mode, for instance if the person is directly in a radiation direction of the antenna (the antenna can be electronically or mechanically rotated in a direction provided for transmission, for instance as a parabolic mirror), or even outside a directed radiation direction of the antenna as a result of scattered radiation or reflected radiation. In order to reduce the risk of the person or the object being exposed to a radiation load exceeding particular limit values inside the safety zone, the transmission power is immediately reduced or the transmission mode is entirely interrupted or stopped if the person stays in the safety zone. If the transmission power is reduced, this is advantageously carried out to such an extent that a reduced transmission power at a position of the person only results in electromagnetic fields (field strengths) which no longer exceed the limit value. This type of transmission control proves to be advantageous, in particular, if the aircraft is on the ground and work is being carried out on the aircraft, for example maintenance work, de-icing of the aircraft, repairs, inspection work, etc. If persons undershoot a minimum distance to the antenna in this case, these persons can be advantageously immediately protected from radiation by controlling the transmission mode.

The safety zone advantageously embodies an envelope curve which defines a region comprising all possible emission directions and scattered radiation of the antenna or of other objects and surfaces inside this region, at which or as a result of which the radiation at persons may exceed particular limit values. The envelope curve also comprises those regions which are outside the direct emission direction of the antenna but are part of the safety zone on account of possible indirect radiation.

As a result of the automation, it is advantageously not necessary for the maintenance personnel to first of all have to come to grips with the antenna and transmission properties of the respective aircraft type before working on the aircraft. Manual switch-off methods may become unnecessary as a result of the automation. It is therefore advantageously possible to maintain and prepare the aircraft at the airport in a quicker and simpler manner.

The transmission signal from the antenna advantageously has the shape of a radiation cone which is advantageously directed to the expected position of an individual satellite. The orientation with respect to the satellite greatly reduces the risk of a person being inside the radiation cone since persons are rarely directly above the antenna during maintenance work on the aircraft.

The size of the safety zone and the limit values for the transmission power are dependent on the transmission frequency. Parameters such as the transmission frequency, the antenna geometry and the shape of the aircraft are advantageously taken into account when controlling the transmission mode.

During operation, the antenna transmits with a sufficiently high transmission power in order to reach a satellite with a discernible signal strength. Furthermore, the antenna is advantageously also set up to receive a return signal from the satellite, which return signal has a much lower signal strength at the antenna than the transmission signal. The transmission signal and the return signal may advantageously have the same frequency or may differ in terms of their frequency. The antenna may advantageously also comprise more than one antenna and may form an antenna system which is advantageously tuned to a frequency band for transmission and reception. The transmission band and the reception band can be advantageously beside one another in radio frequency or can be the same. For example, the antenna is sensitive to low signal strengths in the region of—150 dBm during reception, with a tolerance range of 1%, 5%, 10% or 20%, for example.

The transmission apparatus advantageously generates a carrier signal by means of a generator, which carrier signal is advantageously forwarded to the antenna via an amplifier.

The apparatus for receiving radiation is advantageously set up to receive electromagnetic radiation, for example radio radiation. This can be advantageously emitted by the satellite and/or by another object and may be in a different frequency range or the same frequency range as the transmission frequency of the transmission apparatus.

According to one exemplary embodiment of the method, the antenna is set up to receive a reflection signal which is produced by reflection of the signal at the person inside or at the edge of the safety zone and is received via the antenna in method step C) and is detected by the reception apparatus.

If a person enters the safety zone or stays directly at the edge of the safety zone, the person, in particular if he/she is in the radiation cone of the antenna, can absorb the radiation from the antenna and can reflect a portion of said radiation, advantageously back in the direction of the antenna. The antenna is advantageously set up in such a manner that, despite the losses in radiation intensity of the radiation from the antenna to the position of the person, advantageously at least to the boundary of the safety zone, after partial absorption of the radiation by the person, and back to the antenna, it can still detect the reflection. In this respect, a reception amplifier can be advantageously connected downstream of the antenna. In order to receive radiation from a person, the antenna can advantageously also be sensitive in directions which do not correspond to the direction of the transmission cone or the transmission direction.

According to one exemplary embodiment of the method, the reflection signal is detected by means of the reception apparatus in such a manner that a frequency of the signal is compared with a frequency of the reflection signal.

The reception apparatus advantageously comprises a reception amplifier. Comparing the frequencies of the transmission signal and of the reflection signal advantageously makes it possible to discern whether the received signal is a reflection of the transmission signal at a person or an object within a safety distance. Furthermore, it is also possible to compare the signal strength of the transmission signal and of the received signal.

According to one exemplary embodiment of the method, the reception apparatus comprises a frequency filter which is adapted to a frequency passband in which the reflection signal expected for the signal can be received at the antenna.

The frequency filter can be advantageously set in such a manner that, in addition to the transmission frequencies of the satellite, it also advantageously passes those frequency ranges which correspond or are similar to the transmission frequencies. The frequency filter can be automatically adapted by the reception apparatus after comparison with the signal for transmission.

According to one exemplary embodiment of the method, the reception apparatus comprises a detector which is used to compare a signal received via the antenna with the signal emitted to the satellite, wherein the received signal is identified as the reflection signal by means of a characteristic variable of the signal.

The detector advantageously automatically compares the received signal with the signal emitted to the satellite (by the transmission apparatus) with regard to the frequency, characteristic time scales of the signals (signal propagation times), intensities or the like. In particular, if the wavelength of the transmission signal is known, the received signal can therefore be advantageously identified as the reflection signal.

According to one exemplary embodiment of the method, the transmission signal for comparison is forwarded to the frequency filter and/or to the detector.

The transmission signal is advantageously compared with the received signal by the detector additionally after filtering at the frequency filter in order to be able to identify the received signal as the reflection signal in a more accurate manner (software defined radio). If the received signal is detected by the detector as the reflection signal or as an identification signal from a handheld transmitter (method step C)), method step D) is carried out as a result (the signal from the detector is advantageously processed further internally in the reception apparatus and/or the transmission apparatus).

According to one exemplary embodiment of the method, the detector is used to determine a propagation time difference between the signal and the reflection signal, and the reception apparatus thereby determines a distance between the person and the antenna.

The propagation time difference advantageously makes it possible to determine a number of wavelengths. This information advantageously makes it possible to determine the distance needed by the signal after transmission (emission from the antenna) to pass to the person and back to the antenna again. In this case, the signal generated by the transmission apparatus is advantageously compared with the signal received by the reception apparatus, and any additional time delays caused by components, for example input or output amplifiers in the apparatuses or frequency filters, should be additionally taken into account.

It is also possible to detect and analyse different propagation time differences of multiple reflections at an object, thus producing a more accurate image of the reflection, advantageously also by means of a plurality of antennas.

As a result of an inhomogeneous surface of an object or a person in the safety zone, the reflection can be scattered thereat, which in turn reduces the accuracy with which the distance between the person or the object and the antenna is determined. Such scattered reflections can be advantageously taken into account in the distance measurement, for example by means of a plurality of antennas.

According to one exemplary embodiment of the method, the reception apparatus is used to detect a Doppler shift in the reflection signal and to determine a movement of the person relative to the antenna.

The movement of the person relative to the antenna can be advantageously inferred from the shift in the frequency of the reflection signal in comparison with the frequency of the transmitted signal in the frequency range. It is therefore advantageously possible to automatically determine by means of the transmission apparatus whether the person can be expected to remain in the safety zone for a relatively long time or whether the person will soon leave the safety zone again or when the person enters or does not enter the safety zone. Accordingly, the transmission mode can be influenced differently; for example, it is sufficient to only reduce the intensity of the transmitted signal for a person moving away from the safety zone, but it may prove to be more advantageous to temporarily entirely stop the transmission mode for a person moving further into the safety zone.

According to one exemplary embodiment of the method, the signal is mixed with the reflection signal via a mixer and the Doppler shift in the reflection signal is detected from the mixed signal by means of the detector.

The mixer is advantageously part of the reception apparatus and is connected to the transmission apparatus in order to mix the transmission signal and the reflection signal with one another. A propagation time analysis is advantageously carried out during mixing and further temporal analysis of the reflection signal provides information relating to the number of waves by which the distance between the person and the antenna, as obtained from the propagation time analysis, changes per unit time. This advantageously results in a Doppler shift and knowledge of the movement of the person relative to the antenna. In order to be able to easily mix the two signals, the transmission signal is advantageously a continuous signal.

According to one exemplary embodiment of the method, the signal is generated as a modulated signal.

As a result of a modulated signal, the type of modulation can be advantageously used to identify the reflection signal as belonging to the transmission signal. The transmission apparatus can generate the carrier signal when generating the signal as a modulated signal (by means of a generator). In this case, all common types of modulation can be advantageously used.

In order to detect the Doppler shift, it is also advantageously possible to mix a modulated signal from the transmission apparatus, instead of a continuous signal from the transmission apparatus, with the reflection signal via the mixer, wherein a phase shifter is present in the reception apparatus in addition to the mixer. The detector in the reception apparatus is advantageously coupled to the phase shifter with feedback, wherein the phase shifter advantageously shifts the reflection signal at an intermediate frequency by a time t=2*D/c, where D corresponds to the distance between the person and the antenna and c corresponds to the speed of light.

According to one exemplary embodiment of the method, an identification signal which is emitted by the person by means of a transmitter and is used to detect when the person stays inside or at the edge of the safety zone is detected as radiation in method step C).

An operator of the aircraft can carry, for example, a handheld transmitter which emits the identification signal. The identification signal advantageously has a characteristic signal pattern or a characteristic frequency which can be advantageously detected by the reception apparatus (the detector or a computer).

According to one exemplary embodiment of the method, the transmission is stopped or reduced in method step D) if the signal can generate an electromagnetic field which exceeds a predefined limit value at a position of the person inside the safety zone or at the edge of the safety zone.

During emission of the transmission signal, the computational signal strength at the edge of the safety zone and inside the latter is advantageously inferred. The antenna form and the transmission power provide knowledge of whether the signal strength inside the safety zone or at the edge of the latter can exceed the limit value for the corresponding transmission frequency. If a person is then detected in the safety zone, the transmission mode can be accordingly handled by means of the method, as described above.

According to one exemplary embodiment of the method, communication with the satellite is carried out in the Ku or Ka band.

The Ku band denotes the frequency band from 12 GHz to 18 GHz. The Ka band denotes the frequency band from 26.5 GHz to 40 GHz. In the Ku and/or Ka band, the radius of the safety zone around the antenna is advantageously 20 m to 30 m, for example approximately 26 m (radius of the hemisphere), wherein a tolerance of 1, 5 or 10% is possible. The loss over a distance of 26 m for the transmission signal is advantageously approximately 82 dB at 12 GHz and approximately 90 dB at 28 GHz, wherein a tolerance of 10% is possible. If the Doppler shift is detected, it is possible to detect up to 10,000 waves as the propagation time difference in the Ku or Ka band. Alternatively, operation is also possible in other frequency bands in which the dimensions of the safety zone and the degree of gain and loss are different.

According to one exemplary embodiment of the method, the limit value corresponds to a power density of G=1 mW/cm̂2.

The power density of G=1 mW/cm̂2 corresponds to a conventional limit value for the Ku and Ka bands. A value which is 10% smaller can also be advantageously adopted for increased safety reasons.

Alternatively, the method can also be adapted to other transmission frequencies and limit values.

The aircraft comprises an apparatus for automatically controlling a transmission mode of the aircraft during communication with a satellite, wherein the apparatus comprises a transmission apparatus which is set up to generate a transmission signal. The apparatus also comprises at least one antenna which is set up to emit a signal to the satellite and to receive radiation from a person and from a satellite. The automatic control apparatus also comprises an apparatus for receiving radiation which is set up to detect when a person stays inside or at an edge of a safety zone around the antenna if the person is inside or at the edge of the safety zone. The transmission apparatus is set up to automatically stop the transmission of the transmission signal or to automatically reduce a transmission power of the transmission signal if the person is detected inside or at the edge of the safety zone.

The apparatus for automatically controlling a transmission mode of the aircraft advantageously makes it possible to carry out work on the aircraft, wherein it is possible to automatically take into account when a person stays in a safety zone, according to the method mentioned above, and the transmission mode can be automatically stopped or a transmission power of the transmission signal can be automatically reduced.

Advantageous configurations and developments emerge from the further subclaims and from the description with reference to the figures.

The above configurations and developments can be combined with one another in any desired manner, if useful. Further possible configurations, developments and implementations of the invention also comprise combinations of features of the invention described above or below with respect to the exemplary embodiments, which combinations are not explicitly mentioned. In particular, a person skilled in the art will also add individual aspects as improvements or additions to the respective basic form of the present invention.

### BRIEF DESCRIPTION OF THE DRAWINGS

The present invention is explained in more detail below on the basis of the exemplary embodiments indicated in the schematic figures, in which:

FIG. 1 shows a schematic side view of the aircraft with the safety zone,

FIG. 2 shows a schematic circuit diagram of the transmission and reception apparatuses according to one exemplary embodiment,

FIG. 3 shows a schematic circuit diagram of the transmission and reception apparatuses according to one exemplary embodiment, and

FIG. 4 shows a schematic circuit diagram of the transmission and reception apparatuses according to one exemplary embodiment.

The accompanying figures are intended to provide a further understanding of the embodiments of the invention. They illustrate embodiments and are used, in conjunction with the description, to explain principles and concepts of the invention. Other embodiments and many of the advantages mentioned arise with regard to the drawings. The elements in the drawings are not necessarily shown true to scale with respect to one another.

In the figures of the drawing, identical, functionally identical and identically acting elements, features and components are each provided with the same reference symbols, unless stated otherwise.

### DETAILED DESCRIPTION

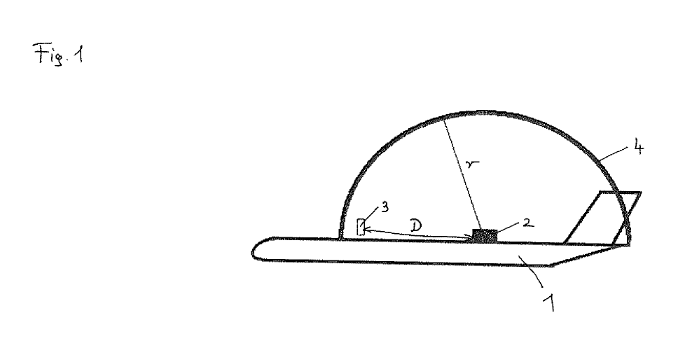

FIG. 1 shows a schematic side view of an aircraft 1, across which the safety zone 4 advantageously directly extends as a hemisphere with the radius r around the antenna 2. If a person 3 now reaches a position D at the edge of the safety zone 4 or enters the latter, the method according to an aspect of the invention is used to detect when the person 3 stays and to stop the transmission mode via the antenna 2 or to reduce the transmission power of the transmission mode. In the Ku or Ka band, the radius r of the hemisphere is advantageously 26 m with a tolerance of 10%, and a conventional limit value for the power density of the transmission signal is G=1 mW/cm̂2.

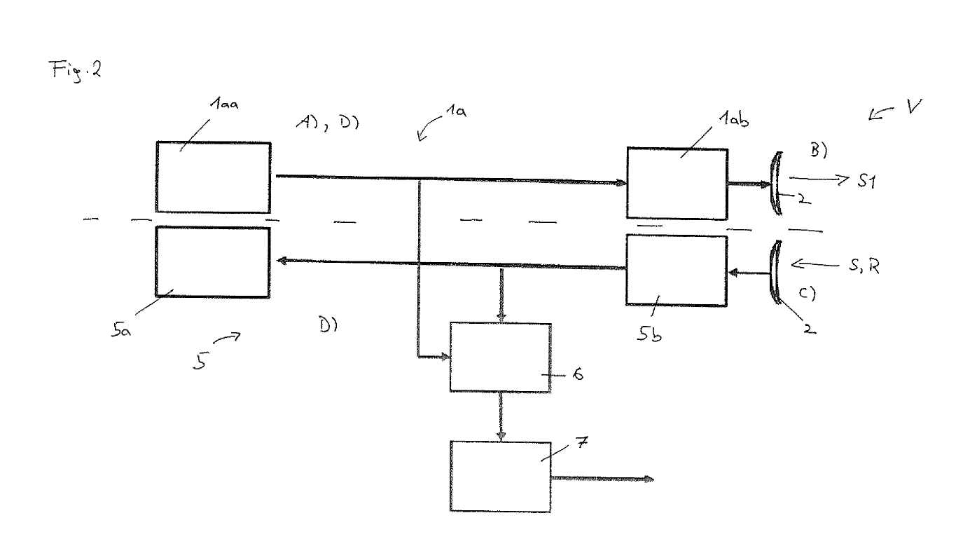

FIG. 2 shows a schematic circuit diagram of an apparatus V of an aircraft, having a transmission apparatus 1a and an apparatus 5 for receiving radiation. The transmission apparatus 1a advantageously comprises a generator 1aa in which a transmission signal S1, which may be continuous or modulated, is generated. This signal S1 can be amplified by an amplifier 1ab and can be emitted to a satellite via the antenna 2. The apparatus 5 advantageously comprises an input amplifier 5b, for example an LNA (low-noise amplifier), which receives, via the antenna 2, a signal S which may be a satellite signal or a reflection signal R from a person. The antenna 2 is advantageously in the form of a directional antenna, for example a parabolic antenna. In FIG. 2, the transmission apparatus 1a and the reception apparatus 5 are schematically each connected to a separate antenna 2, but this may physically be the same antenna 2. Alternatively, however, there may also be different transmission and reception antennas. A frequency filter 6 is advantageously connected downstream of the input amplifier 5b in the apparatus 5 and a detector 7 is in turn connected downstream of the frequency filter. Method steps A), B) and D) are advantageously carried out by the apparatus 1a, and method steps C) and D) (in addition to the apparatus 1a) are advantageously carried out by the apparatus 5. Method step D) can be carried out by the apparatus 1a or jointly by the apparatus 1a and the apparatus 5. After the frequencies have been filtered by the frequency filter 6, the apparatus 5 can advantageously detect, by means of the detector 7, whether the frequency of the received signal S corresponds to the frequency of the transmission signal S1 and whether the signal S is a reflection signal R. In this respect, FIG. 2 shows that the frequency filter 6 is advantageously connected, advantageously directly connected, to the apparatus 1a for this purpose. The passband of the frequency filter 6 can be adapted to the frequency of the signal S1 by means of the connection to the apparatus 1a, with the result that other frequencies which would not correspond to a reflection signal R or to an identification signal from a handheld transmitter belonging to a person are not forwarded to the detector 7 and to a receiver 5a in the apparatus 5. If the detector 7 detects the received signal S as the reflection signal R or as an identification signal from a handheld transmitter (method step C)), method step D) is carried out as a result (the signal from the detector 7 is advantageously processed further in the apparatus 5 and/or the apparatus 1a for this purpose).

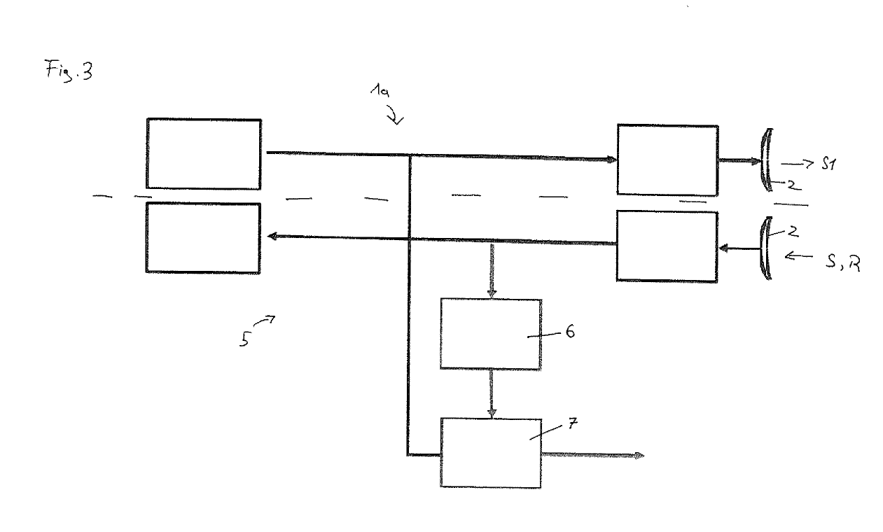

FIG. 3 shows a schematic circuit diagram having a transmission apparatus 1a and an apparatus 5 for receiving radiation according to FIG. 2, wherein the detector 7 is advantageously connected, advantageously directly connected, to the apparatus 1a instead of the frequency filter 6. The detector 7 compares the signal S received by the antenna 2 with a characteristic variable of the transmission signal S1 and advantageously discerns whether the signal S likewise has this characteristic variable and whether it is therefore a reflection signal R. As a result of the transmission signal S1 being compared with the received signal R by the detector 7, it is advantageously also possible to determine a propagation time difference of both signals by means of the detector 7 itself or by means of a further apparatus (for instance a computer) and to calculate a distance between a person and the antenna. If the person is at the edge of or inside the safety zone around the antenna, the transmission mode can be stopped or reduced via the antenna, in which case the apparatus 1a is electronically connected to the apparatus 5.

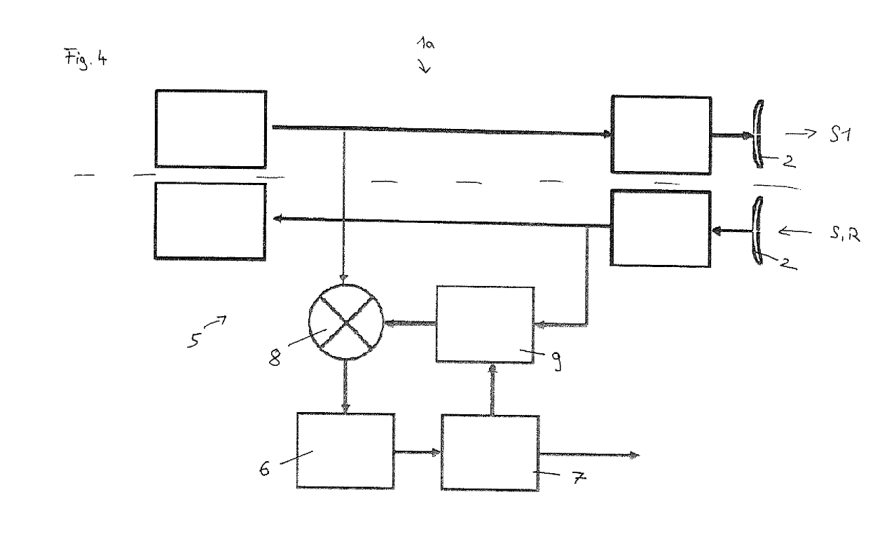

FIG. 4 shows a schematic circuit diagram having a transmission apparatus 1a and an apparatus 5 for receiving radiation according to FIG. 2, wherein, before being filtered by the frequency filter 6, the signal S1 is mixed with the signal S (the reflection signal R) by a mixer 8, and the mixer is connected to the antenna 2 and to the apparatus 1a. If the signal S1 is a modulated signal, a phase shifter 9 is advantageously connected upstream of the mixer 8 coming from the antenna 2, which phase shifter, after the signal S (the reflection signal R) has been converted into an intermediate frequency, shifts the signal S (R) by a time t=2*D/c, where D corresponds to the distance between the person and the antenna and c corresponds to the speed of light. In the Ku or Ka band, this corresponds to a time shift of approximately 173 ns for a person at the edge of the safety zone of 26 m. Up to 10,000 waves therefore correspond to the propagation time difference. The propagation time difference can also be used to infer a Doppler shift in the signal R (in its frequency) and to determine a movement of the person relative to the antenna 2. After the filtered signals S1 and R have been compared, the detector 7 can react to the phase shifter 9 and can tune the latter to the computationally expected frequency of the reflection signal R and/or to the signal S1.

In order to improve the stringency of the representation, various features were combined in one or more examples in the detailed description above. However, it should be clear in this case that the description above is only of an illustrative and in no way restrictive nature. It is used to cover all alternatives, modifications and equivalents of the various features and exemplary embodiments. Many other examples will be immediately and directly clear to a person skilled in the art on the basis of his technical knowledge in view of the description above.

The exemplary embodiments were chosen and described in order to be able to represent the principles on which the invention is based and their possible uses in practice in the best possible manner. As a result, experts can optimally modify and use the invention and its various exemplary embodiments for the intended purpose. In the claims and the description, the terms “containing” and “having” are used as neutral concepts for the corresponding term “comprising”. Furthermore, a use of the terms “a”, “an” and “one” is not intended to fundamentally exclude a plurality of such features and components described.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for automatically controlling a transmission mode of an aircraft while the aircraft is communicating with a satellite, comprising:
A) generating a transmission signal by a transmission apparatus;
B) transmitting the transmission signal to the satellite via an antenna of the aircraft that is set up to communicate with the satellite;
C) detecting when a person stays inside or at an edge of a safety zone around the antenna by an apparatus for receiving radiation from the person via the antenna if the person is inside or at the edge of the safety zone; and
D) automatically stopping the transmission of the transmission signal or automatically reducing a transmission power of the transmission signal by the transmission apparatus.

2. The method of claim 1, wherein the antenna is set up to receive a reflection signal produced by reflection of the signal at the person inside or at the edge of the safety zone, received via the antenna in method step C), and detected by the reception apparatus.

3. The method of claim 2, wherein the reflection signal is detected by the reception apparatus in such a manner that a frequency of the signal is compared with a frequency of the reflection signal.

4. The method of claim 3, wherein the apparatus comprises a frequency filter adapted to a frequency passband in which the reflection signal expected for the signal can be received at the antenna.

5. The method of claim 2, wherein the reception apparatus comprises a detector used to compare a signal received via the antenna with the signal emitted to the satellite, and wherein the received signal is identified as the reflection signal by a characteristic variable of the signal.

6. The method of claim 5, wherein the signal for comparison is forwarded to the frequency filter.

7. The method of claim 5, wherein the signal for comparison is forwarded to the detector.

8. The method of claim 5, wherein the detector is used to determine a propagation time difference between the signal and the reflection signal, and the reception apparatus determines a distance between the person and the antenna.

9. The method of claim 2, wherein the reception apparatus is used to detect a Doppler shift in the reflection signal and to determine a movement of the person relative to the antenna.

10. The method of claim 9, wherein the signal is mixed with the reflection signal via a mixer and the Doppler shift in the reflection signal is detected from the mixed signal by means of the detector.

11. The method of claim 1, wherein the signal is generated as a modulated signal.

12. The method of claim 1, wherein an identification signal emitted by the person by a transmitter and used to detect when the person stays inside or at the edge of the safety zone is detected as radiation in method step C).

13. The method of claim 1, wherein the transmission is stopped or reduced in method step D) if the signal can generate an electromagnetic field which exceeds a predefined limit value at a position of the person inside the safety zone or at the edge of the safety zone.

14. The method of claim 1, wherein communication with the satellite is carried out in the Ku or Ka band.

15. The method of claim 14, wherein the limit value corresponds to a power density of G=1 mW/cm̂2.

16. An aircraft comprising an apparatus for automatically controlling a transmission mode of the aircraft during communication with a satellite, the apparatus comprising:
a transmission apparatus set up to generate a transmission signal,
an antenna set up to emit a signal to the satellite and to receive radiation from a person and from a satellite,
an apparatus for receiving radiation and set up to detect when a person stays inside or at an edge of a safety zone around the antenna if the person is inside or at the edge of the safety zone,
wherein the transmission apparatus is set up to automatically stop the transmission of the transmission signal or to automatically reduce a transmission power of the transmission signal if the person is detected inside or at the edge of the safety zone.
